(19) United States
(12) Patent Application Publication
(10) Pub. No.: US 2004/0066527 A1
(43) Pub. Date: Apr. 8, 2004

(54) Finish verification in printing

(75) Inventors: David Kloosterman, Penfield, NY (US); Timothy F. Donahue, Mendon, NY (US)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/263,438

(22) Filed: Oct. 2, 2002

(51) Int. Cl. G06K 1/00; G06F 15/00

(52) U.S. Cl. 358/1.15; 358/1.1

(57) ABSTRACT

A Finish Verification system used within a Variable Data Printing system that enables all of the sheets of a PPML/VDX job to be reliably tracked throughout the printing system such that any documents that are not properly finished are automatically detected and setup for re-print. A unique bar code on each sheet of a PPML/VDX job is read by a finishing device and compared to a Finish Verification File to verify that all of the required pages comprise each finished booklet. If any error prevents manufacturing any finished documents, a pre-press software application receives this information via an updated Finish Verification File and produces a new PPML/VDX job consisting of just the instance documents that need to be re-printed.

### CROSS-REFERENCE TO RELATED APPLICATIONS

This application is related to the following applications filed on Apr. 9, 2002:

U.S. patent application Ser. No. 10/118,771, filed in the names of David Kloosterman, et al., and entitled, VARIABLE DATA PRINTING USING FAMILY GROUPINGS; U.S. patent application Ser. No. 10/118,772, filed in the names of David Kloosterman, et al., and entitled, VARIABLE DATA PRINTING DYNAMIC IMPOSITION TEMPLATE; U.S. patent application Ser. No. 10/118,773, filed in the names of David Kloosterman, et al., and entitled, METHOD AND APPARTUS FOR USING FIELD OF DATA TO ORGANIZE VARIABLE DATA PRINT JOBS; and U.S. patent application Ser. No. 10/118,770, filed in the names of David Kloosterman, et al., and entitled, VARIABLE DATA PRINTING USING VARIANTS.

### FIELD OF THE INVENTION

The present invention is related to printing, and more particularly to verifying the correct production of documents within a Variable Data print (VDP) job.

### BACKGROUND OF THE INVENTION

Variable Data Printing (VDP) is a form of printing that produces individualized printed pieces, each of which contain printed pages containing information targeted to an individual recipient. VDP authoring combines the graphical arts practice of graphical page authoring with Information Technology (IT) to provide utility to create variable data print jobs that will be input to one or more print production processes in which the printed and finished pieces are manufactured. The various variable content Instance Documents comprising a VDP Job are authored based on data drawn from a database containing records of information that characterizes the individual recipients. VDP is seen as having the potential to enable the high degree of one-to-one marketing communications for the graphic arts and printing industries as has been seen in one-to-one marketing practice using communication mediums such as the Internet.

A common problem that exists using VDP is that making print jobs using a variable data will typically take longer for a Raster Image Processor (RIP) to rasterize and print than a conventional static print job using non-variable data. Variable print data is sent to a RIP where code for text elements and graphic elements are processed into a raster data format that can be utilized by the marking engine of a digital printer. Therefore, every page having variable data must have each and every code element Raster Image Processed (RIPped). The necessity of having to individually RIP the elements having variable data creates a substantial processing bottleneck compared to RIPping static print jobs comprised of a single document which need only be RIPped once, and the many copies are imaged from the same RIPped result.

Beyond the conventional variable data printing practice of varying page content for respective Instance Documents, it is also possible to vary other characteristics of the printed pieces such as finishing characteristics including binding style, and substrate selection based on rules sensitive to the same recipient database information used in the conditional mapping of page content. In this way, for example, recipients of higher value to the marketing firm for which the VDP Job is produced, can receive a printed piece on a higher quality print media with a higher quality binding, whereas, their lower value customers with less value potential may only receive a corner stapled document that is less expensive to produce but has sufficient marketing impact to be noticed by the intended recipient. This implies the need to store along with the page content and layout data, additional data that expresses the physical characteristics of each piece to be manufactured known as product intent data. The addition of product intent data, which may vary the physical characteristics of the finished documents of the VDP job based on the data profile of the various recipients, may add significant complexity to the manufacturing process workflow in the print provider's environment where the required workflow may not be achievable. Hence, a significant problem exists where it is possible to author a VDP Job without knowledge of the print provider's manufacturing workflow capabilities that is too complex to be produced.

Accordingly, there is an ongoing desire within the graphic arts industry to correct the previously discussed shortcomings within the prior art and to enable a faster form of VDP up to final print production and finishing. It is also desirable to use currently practiced methodology within the print engine. The graphic arts industry needs both a method and an apparatus that can provide an efficient and reliable exchange of variable data for use in variable data print jobs.

A page definition mark up language, called Personalized Print Markup Language (PPML), developed by the Print On Demand Initiative (PODi) is an example of a data format that can represent the layout of the pages of the many unique Instance Documents of a variable data print job. PPML is based on the Extensible Markup Language (XML) and is structured in such a way that content data that is used multiple times under the same rendering context on one or more pages is explicitly identified so as to enable a consuming RIP process opportunities for improved processing performance. Ideally a PPML RIP would process all content elements, including both the identified reused and non-reused content elements, a single time where the re-used elements are stored in a cache after they are first RIPed and then reused as raster data.

Allowing a printer RIP to store and re-use rasterized graphic elements as needed provides a tremendous improvement in processing performance. The ability to re-use these elements also eliminates the need to resend the source code that defines the content element to the printer/RIP multiple times during the same print job. PPML is a significant advancement for variable data printing because it allows a printer/RIP to understand at an object level rather than a page level. It allows a printer/RIP to have a certain degree of intelligence and manipulate the components (objects) that make up a page. It also provides code developers the ability to name objects, which permits the re-use of the objects as needed during printing of a variable-data job.

Variable Data Exchange (VDX) is a standard that has recently been evolving within the Committee for Graphic Arts Technologies Standards (CGATS), as a production tool for variable data in the form of a VDX instance combined with PPML. A VDX instance can be looked at as a compilation of records that define the content and layout of many composite pages. These VDX instances can be used with PPML to create the composite definitions of PPML/VDX Instance Documents. Each composite page of a PPML/VDX Instance Document is an assembly of one or more partial pages or content objects referred to as compound elements. PPML/VDX allows compound elements to be defined once and referenced many times from the various composite page layout instances to effectively reduce the overall size of data for a PPML/VDX instance.

The layout data that describes the composite pages of a PPML/VDX instance is defined using a subset of the previously described PPML. The data format required by the PPML/VDX standard for defining the compound element source data is the Adobe Portable Document Format (PDF) defined and maintained by Adobe Systems®. In PPML/VDX, the source PDL data that defines a compound element that is placed on a PPML defined page layout is always expressed as a page of a PDF file. PDF files used to define PPML/VDX compound elements must contain all the supporting resources such as fonts, image data, and color profiles. PDF files used to define PPML/VDX compound elements must also define all color content in a known reference device or device independent color-space.

VDX requires that the PPML layout data of a VDX instance be stored as a single, randomly accessible PDF object stream that is stored within a PDF file. Depending upon the conformance level, the PDF file embedding the PPML data may also contain some, or possibly all, of the PDF page object definitions required by the VDX instance that results in a PPML layout data object. The PPML/VDX file that has an XML element that contains the PPML and product intent data, referred to as the PPML/VDX Layout File. PDF files that contain only PDF page objects used only for defining compound element definitions and have no XML elements stored within them and may be referenced from the PPML data store in a PPML/VDX Layout file, these PDF files are referred to as a PPML/VDX Content File.

A completely specified device and production workflow independent VDP Job definition is comprised of three basic components, two of which define the appearance of the variable page content, namely layout (also referred to as mark-up) data, and content data. In a PPML/VDX instance, the layout component is defined by the PPML data, and the content component is defined by the PDF data. The third component, known as product intent data, provides the description of the finished product. The product intent data typically includes information such as document binding styles, single and/or two sided print options, substrate types, and other attributes of a print product description required for communicating to a print service provider the definition of the final print products that are to be manufactured. Product intent information does not define the controls of a particular target manufacturing process or device because such information is usually not known to the PPML/VDX authoring agent. These device control parameters are usually only known to the print provider who receives the exchanged VDP Job data. The print provider, therefore, must derive the manufacturing specifications specific to their production workflow or workflows from the product intent, layout, and content data specification created by their customer.

A PPML/VDX instance is created by a data driven merge process referred to as a variable data merge engine. The merge engine typically executes within an authoring environment for variable data. The authoring environment can be located at a different location from the graphic arts establishment that actually prints the final pages of the variable data documents. In some scenarios, a PPML/VDX instance may be sub-divided into several PPML/VDX instances that can be transferred to different locations to be printed. Generation of a PPML/VDX instance by the variable data merge engine is considered a final activity in the somewhat complex process for authoring variable data. The PPML/VDX instance can be transferred to a print production workflow within the same or different operating environment where it can be viewed by a prepress operator, and placed into a final production ready form that is suitable for the digital printer used at that location.

The PPML/VDX is a portable format that is expected to enable growth in the practice of variable data printing within the printing industry. PPML/VDX allows printers with dynamic digital printing capability to participate in variable printing without the need to acquire one-to-one marketing, variable layout design, or data processing expertise. However, PPML/VDX is strictly a final form variable data and layout format that is device independent. Therefore, PPML/VDX does not support the inclusion of data that is specific to a printing device such as imposition layout, trapping parameters, traps, or any printer or general device control information. Accordingly, data that contains specific information for a printing device needs to be added later during the prepress activity when the print job is being prepared for production.

The prior art contains numerous printing systems capable of printing at high speeds. These prior art systems provide various features that the Press or Prepress Operator can use to increase the number of documents that can be printed in a given amount of time. The capabilities of current systems do not include processes that alert the printer if all pages in a finished VDP document are not as specified within the job ticket. This shortcoming within the prior art is particularly true in Variable Data Printing (VDP). There are finishing systems that read bar codes on non-VDP jobs and report errors if something is wrong. For example, a finishing system could be set up to create 100 copies of a 5^{th} page booklet. If each booklet has an “end of set” marker on the 5^{th} page encoded in bar code, then the finisher could generate an error if the anticipated 5^{th} page of a document does not contain the “end of set” indicators. The Machine Operator then has to manually reprint the problematic portions of the job. While the concept of using bar codes on non-VDP jobs to detect errors is common, the concept of using a File Verification File to automatically set up a re-print file is unique to both VDP and non-VDP jobs. There are a number of reasons why the stack of printed sheets might not be exactly correct. One common reason is that multiple feeds can result in the final stack of sheets from the printer having extra blank sheets that must be removed before finishing takes place. Another possible problem can occur when the stack of printed sheets are taken from the printer to the finishing device and one of the sheets is lost or damaged resulting in the Press Operator being required to manually collate sheets to be sure that a stack of imposed and printed sheets is ready for finishing.

Another problem within the prior art involves paper-handling errors in the selected finishing device. Finishing devices occasionally damage sheets within the documents during processing resulting in the need to re-print and finish the damaged booklets. Accordingly, there remains a need within the art for a method and apparatus for finishing that will identify these damaged sheets before the booklets are finished and delivered to the customer.

In view of the foregoing discussion, there remains a need within the art for a printing system that can detail problems that exist within finished booklets.

### SUMMARY OF THE INVENTION

The present invention addresses the previously discussed shortcomings within the prior art printing systems regarding verification that all portions of a print job have been completed. Finish Verification within the present invention is a component provided by the system software that concisely facilitates the process of recognizing situations where Instance Documents were not correctly finished. The Finish Verification as envisioned by the present invention provides the capability to re-print Documents, which for one reason or another, were not completely printed and finished. Another common problem within the prior art that is addressed by this invention involves paper handling errors in the selected finishing device. If any sheet is physically damaged or miss-fed by the finishing device during it's processing, then the entire finished booklet that sheet belongs to needs to be re-printed. It is anticipated that the finishing device will identify any documents that it damages as failures in the Finish Verification File. The recovery scheme of the invention is capable of even recovering Instance Documents damaged in off-line finishing devices. The finishing device input is a stack of printed sheets with bar codes and a Finish Verification File. The finishing device output is a stack of finished documents and an updated Finish Verification File that reflects the results of which documents were properly finished and which ones were not properly finished. The Finish Verification File tracks the job and indicates the status of each Instance Document. The Prepress operator can access the Finish Verification file at any time to read and analyze the contents.

The present invention provides the foregoing features by providing a method and apparatus for manufacturing a print job comprising a printing device capable of rendering a plurality of documents as defined by the print job; an electronic file associated with the printing device, the file containing a status of each of the documents; and a processing element that compares the status of the document within the file with intended imposition as defined in the print job and identifies each of the documents that is not manufactured as defined in the print job.

### BRIEF DESCRIPTION OF THE DRAWINGS

FIG. 1a is an illustration of the basic functions required for Variable Data Printing as envisioned by the invention;

FIG. 1b is an illustration of the preferred device for running the functions shown in FIG. 1a;

FIG. 2 is a diagram illustrating the prepress workflow of a print job from the authoring to the production;

FIG. 3 is a flow diagram illustrating the process of the preferred embodiment of the present invention that characterizes the Instance Documents and classifies them into groups with common characteristics called Families;

FIG. 4 is a flow diagram for the creation of Families within the present invention; and

FIG. 5 is a flow chart for the Finish Verification system as envisioned by the preferred embodiment of the present invention.

### DETAILED DESCRIPTION OF THE INVENTION

The present invention presents a description of the sequence of actions that a system performs upon a Variable Data Print (VDP) Job so that it can be efficiently produced. The preferred embodiment envisions a VDP prepress workflow component that provides a user-friendly utility to the prepress operator for facilitating the production of VDP Jobs. A VDP Job may consist of Instance Documents that differ significantly in terms of how they are to be produced. For example, Instance Documents may vary in terms of: page quantity; media type; the number of pages that exceed the area that can be imaged; page layout (one-sided versus two sided); page orientation (portrait versus landscape); meta-data; number of copies, and finishing. The VDP prepress workflow component will provide the prepress operator with the ability to analyze and view the VDP Job, and then setup the VDP Job within the digital press environment using knowledge of the devices available in the environment such that the VDP Job can be optimally produced.

The preferred embodiment of the present invention provides the VDP prepress workflow component as an Acrobat® plug-in. The Acrobat® plug-in is preferably arranged within a modular architecture allowing each of numerous modules to be standalone, such that each of the modules can be added or deleted incrementally. The VDP prepress workflow component supports the PPML/VDX file format and allows the prepress operator to analyze, view, and prepare a VDP Job for production. The output of the VDP prepress workflow component of the invention is a plurality of production ready jobs.

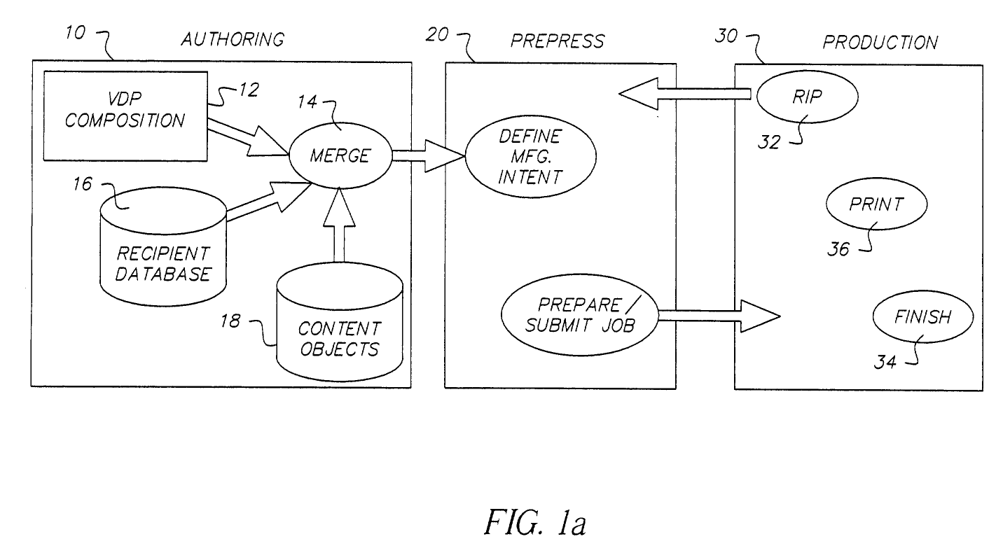

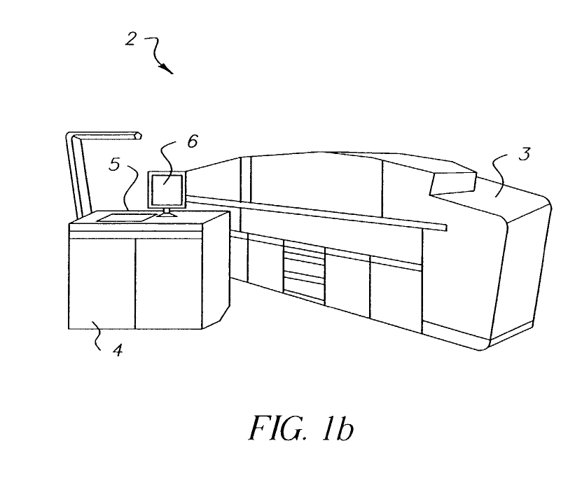

Referring to FIG. 1a, a VDP Job as envisioned by the present invention is accomplished in three basic areas. Authoring 10 provides the PPML/VDX file for the prepress 20. The invention operates in the area of prepress 20 to prepare the VDP Job for production 30. FIG. 1b illustrates a NexPress™ 2100 digital printing system 2 with GUI 6 and NexStation™ 4 providing input and control for printer 3.

Authoring 10 is typically performed by the graphic designer who adds variable content to static content using a utility within VDP composition 12, to add variable content to traditional static designs produced by applications such as Quark® and In Design®. Within the PPML/VDX standard, information known as product intent data may be included in PPML/VDX job data that describes information such as required media types, and binding styles. These product intent elements are encoded into a job ticket (such as PJTF of JDF). Each of these product intent characteristics are referenced from within the PPML data such that the Instance Document definitions defined in said PPML data are provided with a product intent definition. In this way the characteristics of the finished documents such as binding style, media types, copy quantity, and number of pages that exceed the imaging area, all of which contribute to the definition of the finished print product, are explicitly specified for any given document. The present invention will employ NexTreme™ as the tool for VDP Composition 12 within authoring 10. NexTreme™ is a proprietary authoring tool of NexPress Solutions, LLC, that generates the PPML/VDX document provided to prepress 20 and operates to create additional meta-data in the form of extensions to the PPML/VDX variable data which is added by NexTreme™. These extensions can be items taken from the recipient database records such as the recipient's age, gender, postal address, or any other variable data that is specifically associated with the recipient. Authoring 10 will store these extensions as meta-data within the PPML/VDX job 16. The prepress workflow application will later in the workflow draw upon all of the product intent information including the meta-data that is stored in the PPML/VDX job 16 as enunciated by the graphics artist using NexTreme™ to identify the optimal job ticket specification for printing the job.

The variable data, within the preferred embodiment, comes from data in recipient databases 16 that characterize the targeted audience. It is envisioned that the highly customized printed material which results from Variable Data Printing will enable in the printing industry the success being seen today in Internet one-to-one marketing. Merge 14 is a process wherein data from the recipient database 16, is combined with static content data that is contained in content objects 18 to produce the merged PPML/VDX instance document. To understand the description of the merge process 14, a brief discussion of the hierarchical structure of a VDX file is in order.

A VDX file, as used herein, refers to the VDX portion a PPML/VDX file. The PPML/VDX file is, primarily, the utilization of PPML (an implementation of XML technology) to describe the position of PDF objects on every page of a VDP Job consisting of one or more Instance Documents. As previously described, an authoring application is required to author a PPML/VDX job. The preferred embodiment uses NexTreme™ (a proprietary VDP authoring application of NexPress Solutions, LLC), however, other VDP authoring applications can also be used to practice the invention. The graphical artist creates a template consisting of static images, graphics and text as well as variable images, graphics and text in VDP composition 12. The variable parts of the layout will have an associated set of rules that describe the procedures necessary to create each Instance Document. For example, a print job could have a graphical box designated to contain a picture of an automobile for an advertisement to every person listed within a recipient database, the decision for the variable data that will be used for the automobile would be something like the following:

if (income>$100000) then Lexus.pdf;

else if (income>$50000) then Ford.pdf;

else Yugo.pdf.

Therefore, the Content objects 18 database must contain the following PDF files: Lexus.pdf, Ford.pdf, and Yugo.pdf.

Once the VDP Job is composed in a PPML/VDX file format, merge 14 is a process that generates an Instance Document for every record in the recipient database 16. The recipient database 16 is a file containing a database of records relating to metadata of the recipients. For example, the recipient database 16 could very well look like Table 1 below.

TABLE 1

| Name | Income | Age |
|---|---|---|
| Jack Snow | $55000 | 25 |
| Bob Smith | $120000 | 55 |
| Jane Doe | $250000 | 45 |
| Sally Jones | $12000 | 21 |

During the merge process, the VDP authoring application looks at one record at a time from the recipient database 16, and generates a single Instance Document by using the template containing static and variable images, graphics and text. Merge 14 applies the static objects to each of the Instance Documents using the rules as defined by the author for the inclusion of variable objects. In the above example, merge 14 first generates an Instance Document (a VDX file) for Jack Snow. Merge 14 then adds a picture to the Instance Document for Jack Snow and applies the rules that were given by the author during the authoring process which results in the system going to the recipient database 16 and retrieving the file, Ford.pdf. Finally, merge 14 adds Ford.pdf into the VDX file and put an entry in the PPML portion of the file describing where Ford.pdf goes on a specific page for Jack Snow's Instance Document. The result after merge 14 is a VDX file having a PPML portion that describes one Instance Document for each record in the recipient database 16, plus all of the images, graphics, and text objects which usually come from a Content Database.

The preferred embodiment of the present invention is a VDP system that is a scaleable, end-to-end solution utilizing an open PDF based workflow architecture that recognizes the importance of, and supports, the de-coupling of VDP authoring and VDP print production. The process of de-coupling the VDP authoring from the VDP print production has necessitated the creation of VDP prepress workflow components as a tool that can be used by the prepress operator during prepress 20 to optimally manufacture the VDP print job as described from the job producer. The VDP print job, which is received for processing during prepress 20 by the prepress operator, will contain anywhere from one to tens of thousands Instance Documents which lack any structure in terms of pages per document, copies per document, media, pages exceeding imaging area requirements, and finishing options. To enable the accurate and efficient manufacturing of the entire VDP Job as specified by the PPML/VDX file, the prepress 20 component will provide a set of tools to analyze, view, and prepare the VDP Job for the production 30. During production 30, the raster image processor (RIP) 32 will convert the code for each text and graphics element on every page into a format that can be printed by the print engine. After the VDP Job has been RIPped, it printed 36 and finished 34.

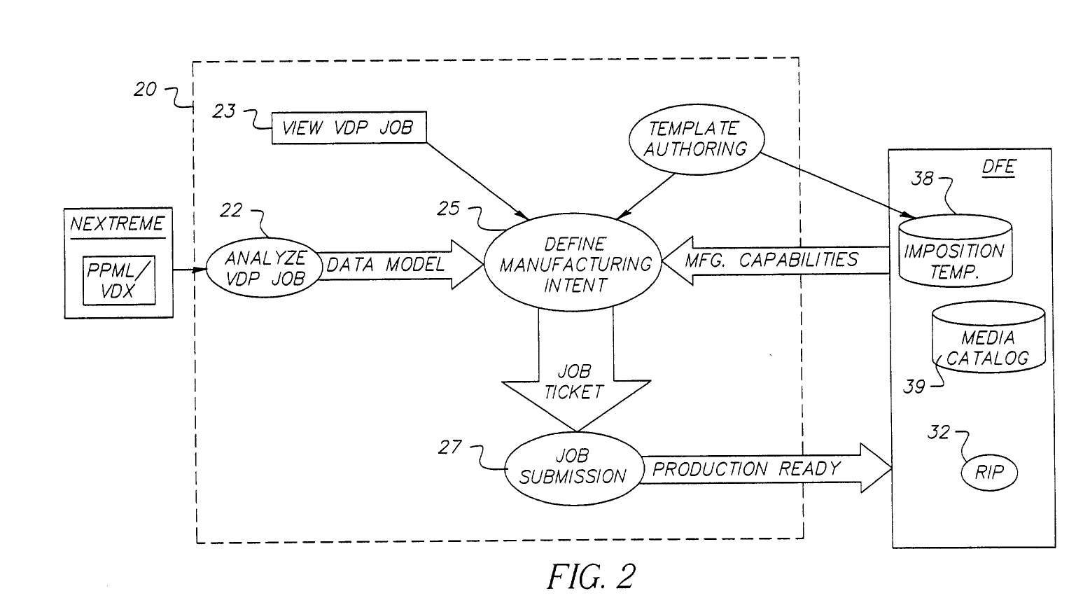

FIG. 2 is a diagram illustrating the workflow performed by the prepress 20 after the PPML/VDX has been received from authoring 10 through production 30. The prepress 20 as illustrated in FIG. 2, will take the VDP Job as an input in the form of a PPML/VDX instance file and provide an output to production 30 that is a VDP Job that is ready to be printed.

The VDP prepress 20 is preferably an Acrobat® plug-in and provides functionality consistent with typical Acrobat® plug-in “look and feel”. Preferably, prepress 20 is provided with high-level functions that give the prepress 20 the ability to: view a VDP Job, analyze a VDP Job; define production parameters for a VDP Job; provide for VDP Job submission; define the finish verification for a VDP Job; and create derivative VDP Jobs.

Still referring to FIG. 2, View VDP Job 23 allows the prepress operator to view the PPML/VDX file as it is to be finished and allows the prepress operator to view a PPML/VDX file, one page at a time, as it would look to the customer after being printed and finished. The prepress operator opens the PPML/VDX file while in the prepress 20 environment, and the first page of the first Instance Document is displayed. Under the standard Acrobat® “Bookmarks” tab, the PPML/VDX file is divided on Instance Document boundaries. The prepress operator can select any Instance Document bookmark and view it's first page. View VDP Job 23 allows the prepress operator to utilize all standard Acrobat® Page-Up/Page-Down features to view the PPML/VDX file. View VDP Job 23 can be run to allow viewing of a PPML/VDX file with minimal performance degradation compared to viewing PDF files by themselves.

The PPML/VDX file is tested upon being opened to determine if it is either “Valid” or “Well-Formed”; definitions of “Valid” and “Well-Formed” are as specified by the Extensible Markup Language (XML) 1.0 and are specified by the prepress operator. Within the preferred embodiment, the VDP prepress software senses that it has opened a VDP file and enables all applicable VDP functionality. Once the PPML/VDX file is opened, the initial view is of the first page of the first document. The prepress operator views other pages by using standard Acrobat® navigational tools.

The preferred embodiment of the invention uses system software to allow viewing of PPML/VDX files as composed PPML/VDX pages (pre-imposed PPML/VDX pages). The default viewing level of the system software is to view all PPML/VDX files as composed PPML/VDX pages. The system software supports standard Acrobat® navigation of pages in a PPML/VDX file by displaying them within the user interface with a unique numerical identifier for each Instance Document. The unique identifier will correspond to the top down order of the Instance Document in the PPML/VDX file. The first Instance Document is Instance Document #1.

The preferred embodiment allows viewing of PPML/VDX pages in a PPML/VDX file as benchmarked against PDF files with little or no performance degradation because viewing a PPML/VDX file is equivalent to viewing a strictly PDF version of the content. The preferred embodiment also supports standard Acrobat® bookmarks for identifying Instance Documents within Instance Documents. Additionally, the system software of the preferred embodiment supports pre-imposed views of PPML/VDX files within the network environment of the application. The system software also supports pre-imposed and imposed sheet views of PPML/VDX files within an accessible NexStation™ 4 environment. It should be noted that this involves supporting part of the proprietary interface to the NexStation™ 4.

The preferred embodiment allows the locking onto a specific page number of an Instance Document such that subsequent navigating via the Page Up/Down keys result in navigating to the same page number of the previous/next Instance Document if it exists.

The View VDP Job 23 performs a function that allows the PPML/VDX file to be viewed as it is to be printed (finished). This will enable a prepress operator to view sheets within a PPML/VDX file, one at a time, as the sheets would look after being printed. Once the prepress operator successfully opens a PPML/VDX file with the prepress component, the option to view the file as imposed can be selected by the operator via the GUI 6. If an Adobe® Job Ticket (PJTF or JDF) is already associated with the PPML/VDX file, the viewer shows the imposed sheet surface. This view includes page layout, relevant document marks (trim, fold, bleed, bar codes), and annotations. The preferred embodiment does not provide bookmarks in this view, because there is no rule preventing Instance Documents from overlapping on sheet surfaces. The prepress operator can utilize all standard Acrobat® Page-Up/Page-Down features to view the PPML/VDX file. Minimal performance degradation can be expected while viewing a PPML/VDX file in the imposed view when benchmarked against viewing a PPML/VDX file in the pre-imposed view.

In order for the prepress operator to run View VDP Job 23, the PPML/VDX file is first opened by system software and an Adobe® Job Ticket (PJTF or JDF) is associated with the PPML/VDX file to describe the imposition layout for the VDP print job. The prepress operator selects an option via the GUI 6 that will allow viewing of the PPML/VDX file as it is to be printed in imposed form. The prepress operator can view other pages as well by using standard Acrobat® navigational tools. The preferred embodiment envisions allowing select viewing of the PPML/VDX file in an imposed form by supporting Adobe® Job Ticket (PJTF and JDF) layout parameters. A sheet surface view of a PPML/VDX file as specified by the associated Adobe® Job Ticket is provided with features such as page layout, document marks (trim, fold, bleed, bar codes), and annotations. The system software provides imposed views of PPML/VDX files within the network environment of the application. Imposed views of PPML/VDX files within an accessible NexStation™ 4 environment are also supported. Accordingly, the preferred embodiment is described in a manner that is specific to a NexStation™ 2100 environment, however, variations will be readily apparent to those of ordinary skill in the art that can easily be ported on other pieces of equipment.

### View PPML/VDX File as a List of PDF Objects (Not Composed)

View VDP Job 23 provides the prepress operator with the capability of viewing a PPML/VDX file, one PDF object at a time. In order to accomplish the viewing of single PDF objects, the system provides viewing of the PPML/VDX file as a sequence of randomly accessible PDF objects. After the prepress operator successfully opens a PPML/VDX file with the software for the prepress 20, the option to view the file as a randomly accessible list of PDF objects is selected. The viewing of the PPML/VDX file as a list of PDF objects can be helpful in debugging the appearance of the PPML/VDX content. There are no bookmarks in this view, since the objects in this view are independent of any page or Instance Document. The prepress operator can utilize all standard Acrobat® Page-Up/Page-Down features to view the PPML/VDX file.

### Analyze VDP Job

The routine Analyze VDP Job 22 allows the system to characterize all of the Instance Documents in the VDP Job as they are delivered by the producer after authoring 10. The characterization made by Analyze VDP Job 22 yields information that allows the prepress operator to accurately and efficiently manufacture the entire VDP Job. A VDP Job within the preferred embodiment can consist of from 1 to more than 10,000 Instance Documents. The Instance Documents can vary from one to the next in terms of: page count; the number of pages that exceed the area that can be imaged upon; number of copies; logical finishing, Bind or Saddle-Stitch for example; page layout, one-sided, two-sided head to head or two-sided, head to toe for example; or orientation, such as portrait or landscape. Also Instance Documents can have variations in the logical sequence of media required. For example, each of the following is a unique sequence of media: A4, A4, A4; A4, A4, A4, A4; A4, A4, A3 and A3, A3, A3 A3, A3. Additionally, meta-data can vary in the Instance Documents. Meta-data in the context of a VDP Job typically refers to information extracted from the recipient database and associated with an Instance Document. For example, a database may have a field containing the zip code of each person to receive a brochure. The VDP authoring application may allow the author to associate the value of each recipient's zip code with the resulting Instance Document in the “Private_Info” element of a PPML/VDX file. This meta-data information can then be used later in the workflow as a variant to a VDP Family.

Each of the variants within the Instance Documents is important because they impact how the printed document is to be produced which can impact the selection of a device, or the way a particular device is to be used; most notably, the imposition scheme.

Analyze VDP Job 22 characterizes all of the Instance Documents within a print job and places the characterized Instance Documents into groups referred to, herein, as VDP Families. A VDP Family is a group of Instance Documents having identical values for the set of variant parameters chosen by the prepress operator within a VDP Job. From the list of VDP Families and their corresponding parameters, the prepress operator can determine how to manufacture the entire VDP Job. With the benefit of the characterization from Analyze VDP Job 22 to work from, the prepress operator may choose to manufacture each VDP Family uniquely, or group any or all of the VDP Families together to be manufactured in a predetermined manner. Grouped VDP Families can be manufactured the same, or have some members of the group of VDP Families having one or more similarities in variants manufactured the same.

In order for the prepress operator to be able to navigate the VDP Job within prepress 20, it is necessary to be able to analyze the VDP Job functionality. Analyzing VDP Job functionality within the preferred embodiment is accomplished by selecting a tab for Analyze VDP Job 22 that is consistent with Acrobat® “Look and Feel”. The prepress operator is given the opportunity to select which VDP Family variants to discriminate against. This could also mean supplying corresponding check boxes to each of the following variants: page count; media sequence; pages exceeding the imageable area ; copy counts, layout sequence, orientation sequence, meta-data; and finishing. The prepress operator clicks on a button that initiates the VDP Job analysis. The VDP prepress workflow Software component scans the entire XML portion of the PPML/VDX file, and subsets the Instance Documents into VDP Families, which are a unique set of parameters as specified by the list of variants chosen by the prepress operator. The VDP prepress 20 displays in a clearly formatted text box for each Family, the number of Instance Documents it contains and the parameter value of each variant. For example:

Family 1—

Contains 935 Instance Documents

Page Count=6

Media Sequence=A4, A4, A4, A4, A4, A4

Exceed the imaging area Specified on Pages=none

Copy Counts=1

Finishing=Bind

Layout Sequence=one-sided, two-sided-head-to-head, two-sided-head-to-head, two-sided-head-to-head, two-sided-head-to-head, one-sided

Orientation Sequence=portrait, portrait, portrait, portrait, portrait, portrait,

Meta-Data: Zip Code=12345

Family 2—

Contains 60 Instance Documents

Page Count=7

Media Sequence=A4, A4, A4, A4, A4, A4, A4

Exceeding the imaging area Specified on Pages=none

Copy Counts=1

Finishing=Bind

Layout Sequence=one-sided, one-sided, two-sided-head-to-head, two-sided-head-to-head, two-sided-head-to-head, two-sided-head-to-head, one-sided

Orientation Sequence=landscape, portrait, portrait, portrait, portrait, portrait, portrait,

Meta-Data: Zip Code=55555

Family 3—

Contains 5 Instance Documents

Page Count=6

Media Sequence=A4, A4, A4, A4, A4, A4

Exceed imageable area Specified on Pages=1, 3, 6

Copy Counts=1

Finishing=Bind

Layout Sequence=one-sided, two-sided-head-to-toe, two-sided-head-to-toe, two-sided-head-to-toe, two-sided-head-to-toe, one-sided

Orientation Sequence=portrait, portrait, portrait, portrait, portrait, portrait,

Meta-Data: Zip Code=98765

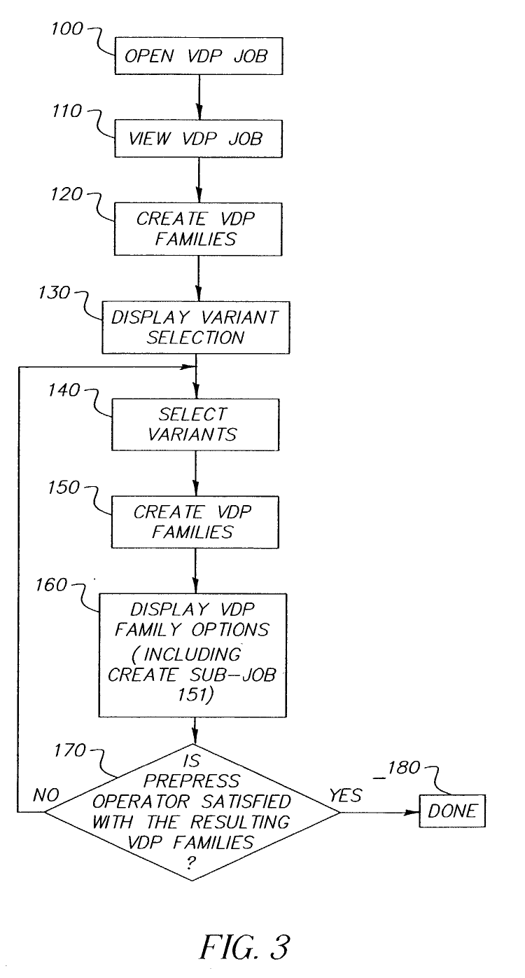

FIG. 3 is a flow diagram of the routine used by, the preferred embodiment of the present invention that is responsible for characterizing all of the Instance Documents and arranging them into groups called VDP Families. A VDP Family is a group of Instance Documents within a VDP Job that contains equivalent values for the set of variants chosen by the prepress operator. It should be noted that an equivalent value as used within the context of the invention, is either a single value or a range of values, which each Instance Document within a VDP Family satisfies. From the list of VDP Families and their corresponding variants, the prepress operator should be able to clearly determine how to manufacture the entire VDP Job. With the benefit of the PPML/VDX analysis to work from, the prepress operator may choose to manufacture each Family uniquely, or group any or all of the Families together to be manufactured the same.

Still referring to FIG. 3, open VDP Job 100 is the entry point in the routine where the prepress operator opens the VDP prepress workflow component, which in the case of the present invention comprises opening a VDP Job. Observe VDP Job 110 invokes the View VDP Job 23 capabilities previously discussed and allows the operator to view the composed form of the VDP Job as it exists within the workflow application. An application menu pops up on GUI 6 and the prepress operator initiates the creation of VDP Families by selecting Start VDP Families Creation 120 from the application menu. The selection of Start VDP Families Creation 120 by the prepress operator results in the activation of Display Variant Selection 130. Display Variant Selection 130 is a display provided by the GUI 6 that presents a variety of variant parameters, that provides the prepress operator with a tool for the selection of variants by which Instance Documents will be sorted into VDP Families. Select Variants 140 is the process whereby the prepress operator selects variants from a combination of check boxes and text entry fields provided by Display Variant Selection 130. The variants chosen by the prepress operator will be used to create the VDP Families. Examples of variants are pages per Instance Document, number of copies required, media used, finishing requirement, pages that exceed the imaging area, page layout, page orientation, meta-data, etc.

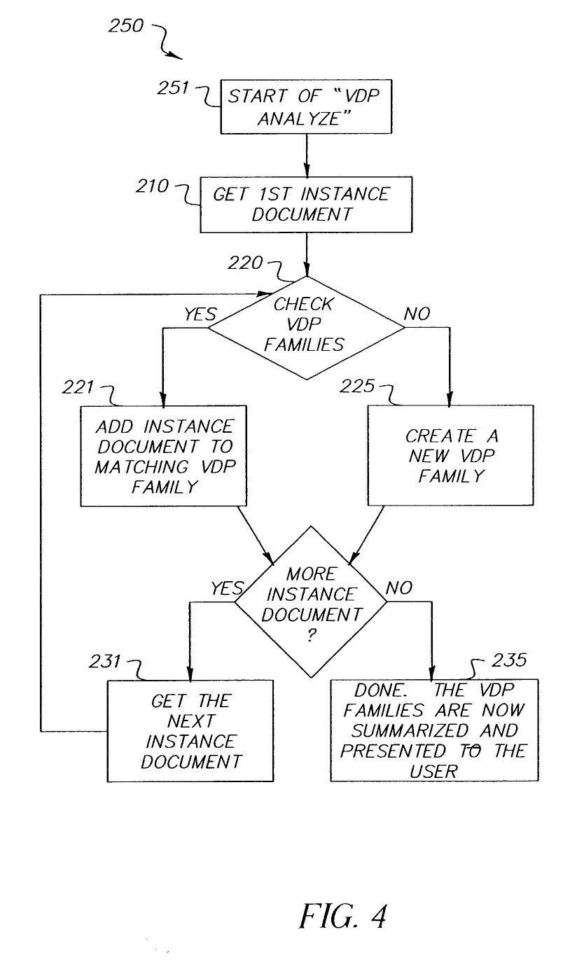

The prepress operator selects the variants that are to be employed, and the creation of VDP Families is initiated by VDP Analyze (a more detailed flowchart for the Create VDP Families 150 component is illustrated in FIG. 4 and will be discussed in more detail below) to create the desired VDP Families. Once Create VDP Families 150 has run, Display VDP Family Options 160 presents the prepress operator with a list of VDP Families generated from the selected variants with the number of Instance Documents belonging to each Family along with the variant's corresponding values. Satisfied with VDP Families 170 allows prepress operator input to indicate if the list of VDP Families is desirable or not. If the prepress operator is not satisfied, then the operator can indicate this dissatisfaction by inputting via the GUI 6 and operation is returned to Select Variants 140 where another list of parameters is selected. Once the prepress operator is satisfied with the list of VDP Families then an indication is made via the GUI 6 and the creation of VDP Families is Done 180. It should be noted that it is assumed that VDP Families are selected such that the overall VDP Job is broken apart into groups of Instance Documents that can be manufactured alike providing for an overall improvement in the reliability and efficiency of fulfilling a VDP Job.

Create Sub-job 151 is an optional routine that is provided in Display VDP Family Options 160. Create Sub-job 151 can be run by the operator after Create VDP Families 150. Create Sub-job 151 is used when the operator believes that the VDP Job is too large to be a single job, or for any reason that the operator desires to create jobs that are sub-sets of the VDP Job. Create Sub-job 151 will be discussed in more detail below.

FIG. 4 is a flowchart illustrative of the VDP Analyze 250 routine used to perform the Analyze VDP Job 22 function that sorts Instance Documents to determine which VDP Family an Instance Document should be associated with. As previously stated, the VDP Families are created by a software component called Create VDP Families 150 that accepts a Variable Data Printing (VDP) job comprising many unique sub-documents (Instance Documents) and sorts them into groups of equivalent variants called VDP Families. VDP Analyze 250 begins once the VDP Job enters prepress 20 after the VDP Job has been authored in the file format that is being employed. The preferred embodiment employs a PPML/VDX file format to author the VDP Job. However, it will be understood by those skilled in the art that other file formats can also be used in place of a PPML/VDX file. Before the VDP Families routine illustrated in FIG. 4 can be run, the VDP Job File (a VDX file in the preferred embodiment) is opened. The prepress operator then selects the desired variants and the sort routine is initiated via operator input to the GUI 6.

The VDP Job description contained within the PPML/VDX file has numerous variants for the VDP Job. The variants may include: page count; media types; number of copies; pages that exceed the imaging area; and finishing. The variants are specified by the prepress operator and result in groupings that can be used as parameters. A group of Instance Documents within a VDP Job having equivalent variants can be sorted using variants as parameters to find the VDP Family. The preferred embodiment of the invention, a VDP Family will generally be determined by grouping on the order of about 5 parameters, however, the number of parameters can vary and the actual number employed can be more or less than 5 parameters or even a single parameter is possible. The operator selects the list of parameters used to sort Instance Documents into a particular VDP Family by entering the desired variants via the GUI 6. It would also be possible to have predetermined VDP Families with a predetermined list of parameters that determine the characteristics of a VDP Family. An example of a predetermined VDP Family is a sort routine run with three variants as parameters that characterize the VDP Family, such as: the number of pages per document; the finishing request; and the media. The parameter selection, preferably, implies which variants the prepress operator deems as relevant in helping manufacture the print job. Preferably, each Instance Document is sorted into exactly one VDP Family per sort operation. If another sort operation is performed applying different variants, then a particular Instance Document will be associated with a different VDP Family in accordance with that sort operation. It should be understood that while associating each Instance Document with only a single Family is the preferred mode of practicing the invention, other groupings are also possible wherein an Instance Document is associated with multiple Families simultaneously, and these differing embodiments will be readily apparent to those skilled in the art.

The Start VDP Analyze 251 routine begins with a VDP Job as defined by the PPML/VDX file and a list of variants supplied by the operator to use for creating VDP Families. Once the VDP Analyze 250 algorithm is entered, Get 1^{st} Instance Document 210 begins with an empty set of VDP Families and retrieves the first Instance Document in the VDP Job. This first Instance Document is then examined to determine if an existing VDP Family has a matching set of variants by the routine.

Check VDP Families 220 compares the variants selected by the prepress operator with the variants that are listed within PPML/VDX file for the first Instance Document to see if there is an existing VDP Family with parameters equivalent to those listed for the current Instance Document. The variants that the prepress operator can select include: page count; media types; number of copies; pages that exceed the imageable area; finishing; page layout; page orientation; meta-data; and other possible variants. The list of possible variants is not a closed list and it is specifically envisioned by the present invention that other variants can be employed. Check VDP Families 220 verifies that the selected variants exist within this Instance Document and that there is a match for a VDP Family already created for this VDP Job. If there are variants within the Instance Document that are not found within the group of parameters specified by the prepress operator, then the routine Create a New VDP Family 225 is run to generate a new member to the list which is a match for the present Instance Document. Create a new VDP Family 225 creates a new member of the VDP Family with parameter values equivalent to the current Instance Document and then adds the current Instance Document to the new VDP Family member. If the variants specified by the prepress operator are found within the Instance Document, the Instance Document is then associated with the VDP Family that matches by Add Instance Document into VDP Family 221 which will place the current Instance Document to the VDP Family that has equivalent parameter values for all of the variants that are selected by the user.

More Instances Documents 230 will look to the list of Instance Documents to determine if there are any more Instance Documents in the VDP Job. If there are more Instance Documents to be sorted by VDP Analyze 250, Get Next Instance Document 231 will get the next Instance Document, and return to Check VDP Families 220 to compare the variants that are listed within the PPML file for this next Instance Document to find a VDP Family that matches the variants listed. The previously discussed steps for Check VDP Families are then repeated. The list of Instance Documents will be sorted through until a false answer for More Instance Documents 230 results in a return to the calling VDP Family routine and the VDP Family Sort is completed.

Once the VDP Analyze 250 completes the VDP Families sort routine, Done 235 will provide summarized information relating to the VDP Families to the prepress operator that will allow the prepress operator to understand and manufacture the entire VDP Job accurately and efficiently. The analysis results in sorting every Instance Document into a VDP Family and describing the characteristics of each VDP Family in order to allow the prepress operator to instruct the NexStation™/printer how to manufacture the job. The directions to the NexStation™ 4 describing how to print each VDP Family are contained in a data structure called a job ticket. The job ticket is preferably a Portable Job Ticket Format (PJTF), which is a standard file format that is created by the Adobe® job ticket and widely supported throughout the industry. Many companies have developed their own proprietary job ticket programs. While the present preferred embodiment employs PJTF, it is specifically envisioned that future embodiments will eventually migrate to another format known as Job Definition Format (JDF). After the result of the VDP Analysis is available and the VDP Families are identified, the prepress operator selects/creates a job ticket to print the job. The job ticket is written in a standard file format that is compatible with software on the NexStation™ 4. Therefore, the NexStation™ 4 comprehends the information in the Job File, and: which media to use; how to impose sheets; identifying if each sheet is 1 sided or 2 sided, or the type of finish. Once a job ticket is created, it may be attached to the PPML file and submitted to the NexStation™ 4 for fulfillment. Given the results of the analysis, the prepress operator immediately knows exactly what each Family looks like, how many Instance Documents are in each VDP Family, and can therefore create a job ticket ideally suited for each VDP Family. The job ticket associated with each VDP Family then tells the NexStation™ 4 which media types to use for each sheet, how to apply imposition of pages onto sheets, how many copies, how to finish, etc.

The prepress 20 component provides an Acrobat® standard User Interface for launching the Analyze VDP Job 22 function on a PPML/VDX file. The Acrobat® standard User Interface supports the specification of virtually any combination of variants (including support for wildcards) that Analyze VDP Job 22 uses as criteria for creating VDP Families (i.e. a column of variants each with a corresponding checkbox). An example of a list of variants is page count, media types, copies, number of pages that exceed the imaging area, finishing and any variants explicitly specified through “PRIVATE_INFO” within the PPML/VDX file. Prepress 20 allows for a valid hierarchy of PPML/VDX tags and attributes to be entered as a variant (such as differentiating Families by Zip Code in PRIVATE_INFO: <PRIVATE_INFO><Zip_Code>12345</Zip_Code></PRIVATE_INFO>). The results of the “Analyze VDP Job 22” are displayed in a clearly formatted text box on the user interface; and for each Family, displays the number of Instance Documents it contains and the parameter values of each variant.

Referring again to FIG. 3, after opening a PPML/VDX file and running Create VDP Families 150, the prepress operator has several selections to choose from presented by Display VDP Family Options 160. One of the presented options is Create Sub-job 151. Tools for selecting a set of Instance Documents are presented by the prepress workflow software component. Upon completion of selecting the set of Instance Documents for the new job, the new job is saved as a complete PPML/VDX file.

The invention provides the capability of creating a new VDP Job as a subset of a larger VDP Job. It is sometimes desirable to process a VDP Job as a group of separate, smaller VDP Jobs. Additionally, it may be desirable to create a new VDP Job that is a subset of a larger VDP Job. In each case, production advantages are gained in terms of the cost of collating, organizing and arranging the printed documents. The arrangement of printed documents can be based on any of numerous features. Efficiency in arranging final products is achieved through knowledge of the types of media, size of media, and eliminating much of the collating for the final printed documents.

A VDP Job may consist of from 1 to more than 10,000 Instance Documents which can vary from one to the next in terms of: page count; logical sequence of media; binding requirements; perfecting requirements; folding requirements; print product delivery requirements (the most cost effective postal sort ordering including sort by zip code and/or finished weight); print media requirements (paper weight, surface texture, brightness, brand); page size (finished size, imposed sheet size); page orientation; or page content bleed requirements.

There are many variants for documents, and even subsets of documents that can be used to categorize production ordering of variable data documents. For example, various subsets of documents or sub documents can be selected with respect to common attributes taken from many combinations of common attributes.

### EXAMPLE 1

Assume that 100,000 Variable Data Print products are to be produced where the printed page quantities of the many print products vary from 4 to 16 pages. It is reasonable to assume that the weight of the various finished pieces will vary proportionally with each piece's number of pages. As such, and as part of bulk mailing optimization; it is very common for mailed pieces to be sorted into some number of bins based on specific weight ranges. Given that the quantity of pages of a finished document correlates proportionally to the finished weight of a piece, then the data itself can be used to estimate a finished piece's weight and be pre-sorted prior to actual production rather then having to be mechanically post-sorted into bins after finishing. Accordingly, using the number of pages within a document as a variant for determining sub-groups has distinct advantages.

### EXAMPLE 2

Assume a job defines Variable Data Print products that have varied content as well as binding requirements. The variation in binding requires some pieces to be saddle stitched and others to be perfect bound. To keep this example relatively simple, assume all documents have exactly eight finished pages, printed two sided head-to-head, and none of the page images that are required to be perfect bound have bleeds (which would otherwise require pages to be imposed on oversized stock and be trimmed which would add to the overall manufacturing cost) and the finished documents required to be saddle stitched have a full bleed center fold (which requires trimming). Also, assume that the printing device to be used can print letter size (8.5×11) or two up letter (12×18). To best produce the job, the characteristics are during an analysis by the operator. The operator then decides to print all finished pieces required to be perfect bound in a first run, and the pieces to be saddle stitched in a second run. Assume that the operator based the decision to make these two runs due to the perfect bound run being very simple to produce because pages have no bleeds and can simply be printed two sided in reader order with separator sheets. Moreover, absolutely no imposition is required and, hence, no trimming is required. The second run, however, is saddle stitched. This means that imposition of four pages on a sheet is required. Also, since the centerfold has a full bleed, all pages must be printed on oversized 12×18 sheets and be trimmed down to a finished 11×17 size prior to binding. From this example, numerous variants are involved to create the two runs. By allowing the operator to apply the variants in a manner that can efficiently produce the final documents, a significant savings in time and effort is achieved by the invention.

The preferred embodiment provides selection criteria for Instance Documents to be placed into a list for further processing. In the context of a proof job, Instance Documents are selected from the VDP for “further processing”. This means submitting the proof job to the press to view the results. Frequently, an operator will then make modifications to color management, media, or layout as a result of the proof before committing the entire job to the press. Take first Instance Document from each VDP family; take every nth Instance Document from each VDP family (n is 1 to 1000); add and/or delete all selected Instance Documents from a VDP family; and add and/or delete specific Instance Documents.

The invention insures the verification of the proper manufacturing of all the documents within a print job by alerting the printer operator of booklets not being manufactured as specified within the print job. A Finish Verification file is provided that tracks the document to be produced in accordance with specifications of the print job. The Finish Verification file contains the print results and frees the printer operator from having to manually collate imposed and printed sheets before the finishing equipment can correctly operate on a stack of imposed sheets. The Finish Verification file provides the printer operator with the ability to verify the correct completion of documents within a print Job. The system can also employ the Finish Verification file to control reprints of any documents that did not manufacture correctly. The Finish Verification file, as envisioned by the preferred embodiment, contains the correct order in which a stack of printed sheets should be arranged for a finishing device to complete the print job. The Finish Verification file is updated by the finishing equipment. A list of documents that need to be manually re-printed can be manually updated. Then PDFStreme™ updates the Job Ticket/Finish Verification File so that the re-print job can be submitted. Review of the Finish Verification file allows the printer operator to reprint any documents that did not print correctly the first time to complete a print job. The Finish Verification file can be updated to include reprints if so desired.

The Finish Verification file within the present invention is a component provided by the system software that concisely facilitates the process of recognizing situations where Instance Documents that were not correctly imposed. The Finish Verification as envisioned by the present invention specifically re-prints Instance Documents, which for one reason or another, were not completely printed and finished. The recovery scheme envisioned by the invention is capable of recovering Instance Documents damaged by off-line finishing devices. The “Finish Verification File” tracks the job and indicates the status of each Instance Document. At any time, the Finish Verification file can be read analyzed and acted upon by this component.

In order to track a print job, the present invention envisions that an indicia be placed on the sheets, preferably, a bar code that is placed on the finally imposed sheets and then comparing the sequence of bar codes with the results to be expected as logged in the Finish Verification file. The system envisioned by the preferred embodiment is capable of reading the bar code (or other indicia) on the finally imposed sheets and comparing the imposed results with the expectations of the print job. Preferably, documents that were not successfully printed are re-printed to allow completion of the finishing of the job as specified.

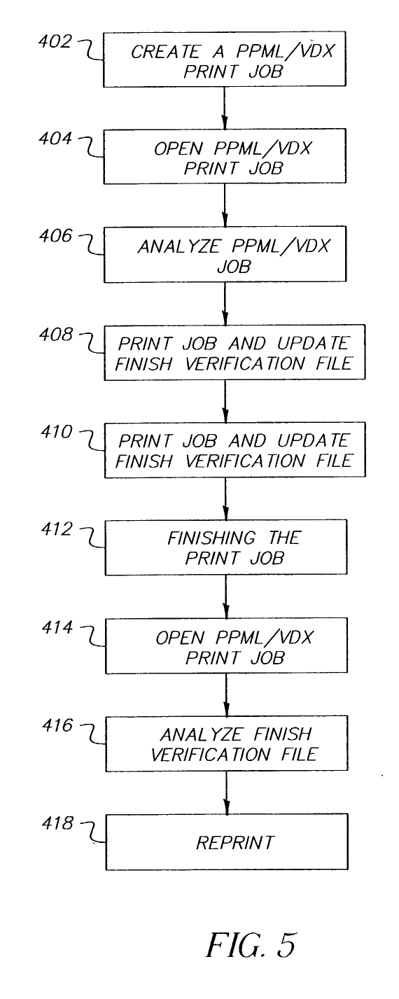

Referring to FIG. 5, which is a flow chart for the Finish Verification system as envisioned by the preferred embodiment of the present invention. Preferably, a graphics designer will employ an authoring application, such as NexTreme™ as previously discussed, to create a PPML/VDX Job 402. A Job Ticket and/or Finish Verification information may or may not be associated with the PPML/VDX Print Job when the PPML/VDX print job is initially authored. The PPML/VDX Print Job will be sent to a digital printing system such as the NexPress™ 2100 as an electronic file. Open PPML/VDX Print Job 404 allows an operator to read the PPML/VDX Print Job and the associated Job Ticket/Finish Verification File (such as a JDF file) using a Prepress Software Application, which in the preferred embodiment is PDFStreme™. OPEN PPML/VDX Print Job 404 is executed by the Prepress operator to open the PPML/VDX, Job Ticket and Finish Verification files. The Finish Verification file will indicate the status of Instance Documents, and specifically, provide information relating to those Instance Documents that have not been manufactured correctly. Analyze PPML/VDX Job 406 is a step that is taken by the prepress operator to look at the PPML/VDX file and the production intent that is delineated therein. The prepress operator will select a device to print the PPML/VDX Print Job (such as a NexStation™) based on the contents of the PPML/VDX file. Modify Job Ticket 408 allows the prepress operator to either create, or modify, the Job Ticket to specify the intended imposition and direct the printing of the appropriate bar codes on each sheet. Submit Job 409 submits the PPML/VDX Print Job to the selected device, with the associated Job Ticket/Finish Verification File

Once the job is submitted to the Printing Device by Print Job and Update Finish Verification File 410, the PPML/VDX file and the associated Job Ticket/Finish Verification file will be used by the printing device to impose and print the job. The entire job is printed as described by the PPML for the page layout, the PDF objects for page content, and the job ticket for product intent. It should be noted, that the job ticket preferably describes the required bar codes which uniquely identify every sheet to be printed in terms of a combination of Job #, Document #, Sheet #, and Copy #. The output from the Printing Device is a printed stack of sheets at the output tray as specified by the job ticket, and a Job Ticket/Finish Verification File. The Finish Verification file describes the sequence of sheets in the printed output stack allowing each sheet to be read with a bar code reader and precisely mapped to its'proper context within the print job.

Once printing is completed, the operator performs the step of Finishing the Print Job 412 by placing the stack of printed sheets into the feeder for the finishing device. The operator loads the Job Ticket and Finish Verification File into the finishing device. The type of finishing device that is envisioned implemented in accordance with the concepts of the invention will have the capability to read the Job Ticket/Finish Verification File as well as the ability to read indicia (preferably bar codes) that is placed on the individual sheets that identify each of the sheets with respect to the imposition definition provided within the Job Ticket/Finish Verification file. The Job Ticket and the Finish Verification file provide the finishing device with the types of finishing operations that are required (i.e. saddle stitch, fold, trim), and the job number, document number, sheet number, and copy number of each sheet in the stack encoded with bar codes. The finishing device feeds each sheet, verifies that the bar code read corresponds to the expected sheet as indicated in the Job Ticket/Finish Verification File, and performs the operation specified in the job ticket section of the Job Ticket/Finish Verification File once all the sheets for a given document are queued. After the finishing device has processed all sheets in the stack, it summarizes the results in the finish verification section of the Job Ticket/Finish Verification File, including which documents (preferably by index number) were not completed properly.

Still referring to FIG. 5, after the finishing device has updated the finish verification section of the Job Ticket/Finish Verification file, the Job Ticket Finish Verification file is transferred back to the printing device where the operator can review the content of the finish verification section by performing Open PPML/VDX Print Job 414 using a prepress application (preferably using PDFStreme™). Open PPML/VDX Print Job 414 opens the PPML/VDX Print job, which has an updated Job Ticket/Finish Verification File from the finishing device, so the operator can perform Analyze Finish Verification File 416 (again preferably using PDFStreme™) to view the contents of the finish verification section of the Job Ticket/Finish Verification File and select those instance documents that need to be reprinted. The operator will select an option that allows analysis of the completed print job from the GUI within the application. The selected analysis option is preferably a software application that looks at the PPML/VDX file and the Job Ticket/Finish Verification File to determine if the job has been properly completed. If the job was completed properly, then the Print Job is done. If the Print Job has sheets that have not been imposed properly, are damaged, or additional blank sheets are accidentally inserted into the stack, then it is envisioned that Reprint 418 be performed by the operator working in conjunction with the Prepress Software Application (preferably PDFStreme™) to reprint those sheet that have not been properly imposed. The Print Job is resubmitted to the finishing device with an updated Job Ticket/Finish Verification File. The finishing device envisioned by the invention will collate the entire print job into the desired booklets using the reprinted sheets and the updated Job Ticket/Finish Verification file.

The Finish Verification File is empty and has no meaning until an imposition scheme is applied to a PPML/VDX job. Until the product intent (via a job ticket or some other means) is applied to a PPML/VDX job, there is no manufacturing/printing specification and accordingly, there is no Finish Verification File at this time. Once an imposition scheme is applied, every page in the VDX job can be mapped to a sheet of paper to be printed and a Finish Verification File is preferably created at this time. The Finish Verification File format is a description of the stack of sheets with each sheet uniquely identified as a combination of job number, copy number, document number and sheet number. Below is an example of a partial listing of a document having a number of sheets referred to as “s”.

Sheet 1: Job #x, Copy #y, Document #z, Sheet #I

Sheet 2: Job #x, Copy #y, Document #z, Sheet #I+1

. . .

Sheet #v (the last sheet in the job): Job #x, Copy #m, Document #n, Sheet #p.

Wherein, the following variable definitions are in effect for the above listing. The # sign designates number. The variable x represents an integer from 1 to 65536 (with 65536 being an arbitrary maximum number), which uniquely identifies every job in the entire printing system. The DFE assigns such a job # when it receives a job. The variable y is an integer from 1 to 65536 (with 65536 being an arbitrary maximum number), which starts at 1 for every job and increments by one for each copy requested in the job ticket. For example, if a job ticket specified 4 copies of an Instance Document, all of the sheets for the first set would have a y=1. Then y=2 for the entire 2nd set, and would continue until y=4 for the final requested set. The variable z is an integer from 1 to 65536 (with 65536 being an arbitrary maximum number), which uniquely identifies every Instance Document within a Job. The variable I is an integer from 1 to 65536 (with 65536 being an arbitrary maximum number), which uniquely identifies every imposed sheet within an Instance Document. The variable m is an integer equal to the total number of copies requested for a given Instance Document. The variable n is an integer equal to the total number of Instance Documents in a given Job. The variable p is an integer equal to the total number of imposed sheets in a given Instance Document. The variable v is an integer equal to the total number of imposed sheets in the entire job.

The prepress operator then selects those Instance Documents that did not complete correctly to be re-printed. The prepress workflow Software component creates or updates the Job Ticket/File Verification File (note JDF is capable of containing both job ticket and Finish Verification information, however it does not need to be implemented this way) to print just the Instance Documents that are required to complete the fulfillment of the PPML/VDX job. The PPML/VDX job is re-submitted to get the missing Instance Documents printed.

It is also possible that an error occurred in handling and a PPML/VDX job that was not identified in the Finish Verification file. The prepress operator may locate the Instance Document(s) to be re-printed in the viewer, and identify them by their numerical identifier. The prepress workflow Software component will allow the prepress operator to add or delete Instance Documents identified in the Finish Verification file by their numerical identifier.

The format of the Finish Verification file, within the preferred embodiment, is a JDF file format, although those skilled in the art will realize that other file formats can also be adapted for this function. An error has been identified in the fulfillment process that cannot be fixed by the printing device's jam recovery capability.

Job Definition

The Print Job is defined in VDX format as follows: this actually models the representation more than literally. The syntax is a bit different in an actual PPML/VDX file

```
Job
    Doc
        Page
            Mark (PDF Objects)
```

Finish Verification File

```
Job
    Doc
        Sheet
    Doc2
        Sheet2
    .
    .
    .
    DocN
```

SheetM (M=N/(the Number of Documents Persheet))

Referring to FIG. 2, within the preferred embodiment, Define Manufacturing Intent 25 is a function that is performed by the prepress 20 in order to define the production parameters that are responsible for manufacturing the job as intended. Define Manufacturing Intent 25 is a function that sets the production parameters accurately and efficiently, to print and finish the print job as specified in a PPML/VDX file. The prepress operator should be aware of the capabilities of the device in order to determine the optimal way to print and finish a PPML/VDX job. Therefore, one of the functions of Define Manufacturing Intent 25 is to query the printing device (the NexStation™ 4 in the case of the preferred embodiment) for its “Manufacturing Capabilities”. Included in “Manufacturing Capabilities” for the device are the “Media Catalog”, the “Static Imposition Template Catalog”, and the “Finishing Capabilities”. Communication between the prepress 20 component and the PPML/VDX Job Production 30 component provides a list of the available media types is obtained from the Media Catalog 39. The prepress operator maps each logically specified media in the VDP Family to a physical media type supported in the Media Catalog 39 of the device's Manufacturing Capabilities. An imposition scheme is selected that will accurately and efficiently print each Instance Document of the VDP Family. An imposition scheme for a VDP Family can be specified in several different ways:

Selecting an Imposition Template from the device's (NexStation™ 4 in the case of the preferred embodiment) “Static Imposition Template Catalog”

Don't specify any imposition scheme and thus allow the device to perform imposition using it's default imposition scheme

Associate a job ticket from the file system which contains an “Static Imposition Template”

Select parameters for specifying a simple (typically 1-up) “Static Imposition Template”

The selection of a Static Imposition Template for a VDP Family involves consideration of the mapping of the logically specified media and finishing specifications in the PPML/VDX to the physical capabilities of the device. PPML/VDX pages may have a logical media name (such as “Heavy Letter”, “Insert1”, or “Dave's Favorite Paper Type”) which the prepress operator assigns to a specific paper defined in the device's Media Catalog (such as “Hammermill #06200-8”) based on communication between himself and the PPML/VDX job producer. Additionally, the prepress operator determines what page layout will yield the best results. The VDP Family may have a logically specified finishing requirement (such as “Saddle-Stitch” or “Bind”) which needs to be mapped to a physical finishing capability of the device and defined in an Adobe® Job Ticket. Lastly, the number of copies to be produced of each Instance Document in the VDP Family needs to be considered. There are some cases (i.e. business cards, postcards) in which multiple copies of the same Instance Document should be imposed in a particular orientation. The assigning of a static imposition template and Job Ticket will direct the device to accurately and efficiently produce the VDP Family.

The system software of the present invention is able to define the production parameters of a PPML/VDX job by treating the entire file as a single Family. This intermediate level of functionality is viewed in conjunction with the capability of having the ability to split a multiple VDP Family job into single VDP Family Sub-jobs. The functionality of treating the PPML/VDX job as a single file allows for a single file production of a PPML/VDX job with multiple VDP Families.

Once the PPML/VDX file has been opened by the prepress component 20, the prepress operator will obtain the results of Analyze VDP Job 22. In order to Define Production Parameters, the prepress operator selects a device (NexStation™ 4 in the preferred embodiment) and queries the device (NexStation™ 4) for its manufacturing capabilities. Once the manufacturing capabilities are received, the prepress operator selects a VDP Family from the list created by Analyze VDP Job to define the production parameters needed for manufacturing that subset of the PPML/VDX Job.

A communications interface between the prepress 20 and production 30 areas allows the prepress operator to map the logically specified media and finishing contained within the VDP Family to a physical media and finishing option supported in the device's Manufacturing Capabilities.

After reviewing all production parameter selections, the prepress operator may accept the selections for that VDP Family. The result of the production parameter selections is then put into a job ticket which will describe the manufacturing intent of the production parameters, and reference which Instance Documents within the PPML/VDX Job that this set of production parameters are to be applied. Note that within the preferred embodiment, the job ticket format will be PJTF or JDF, however, it should be understood that other formats can be employed as will be readily apparent to those skilled in the art.

The foregoing steps are then repeated for each VDP Family from the Analyze VDP function. The prepress operator then confirms that all VDP Families are properly specified for production. Any final job ticket processing is completed. The PPML/VDX Job is then ready for submission.

The Define Manufacturing Intent uses system software to present results of Analyze VDP Job 22 on the GUI 6 which then allows the prepress operator to specify all required production parameters for each VDP Family. The list of required parameters to be specified for each VDP Family from the Manufacturing Capabilities provided by the selected NexStation™ 4 are as follows: the number of copies of each Instance Document in the VDP Family to be produced; a default physical media type for all PPML/VDX pages not explicitly specified with a logical media type; a physical media type for each logical media type specified; a static imposition template; and finishing capability.

The system software requests the prepress operator to confirm when finished making production selections on any or all VDP Families. It is, therefore, not required that all VDP Families be selected for production. The system software adds the confirmed production selections for all VDP Families into Adobe® Job Ticket(s), which in the preferred embodiment is based on PJTF, however, it will be readily apparent to those skilled in the art that other data structures can also be employed, such as JDF for example. The system software supports rule based job ticket merging after a Job Ticket has already been embedded into a PPML/VDX Job by a prior process. The system software embeds the associated Adobe® Job Ticket(s) into the PPML/VDX file as specified by Adobe® for PDF files.

Job Submission 27 is a function that provides the operator of the prepress 20 to open the PPML/VDX file and perform desired actions prior to submitting the PPML/VDX file to production 30. Job submission 27 submits a job in a PPML/VDX format to a printing device for fulfillment after all operations on the VDP Job are completed by the prepress 20 operator. In the preferred embodiment, Job Submission 27 is done as a single file exchange. The preferred embodiment implements a single file which contains all of the PPML, referenced PDF objects and any associated job ticket. However, it is specifically envisioned that in other implementations that allow for a multi-file submission, the PPML may refer to PDF objects in an external file.

Job Submission 27 begins with the operator for prepress 20 selecting the device to print on, which in the preferred embodiment is the NexStation™ 4, however other devices also are envisioned as being supported. For example, if all pages in a job are to be printed in black and white, then a black and white printer would be the preferred device. In the prepress 20 area, the prepress operator logs into the device, depending upon the configuration of the device, and selects “Print Properties” to access device dependent capabilities. The desired print parameters that the device presents to the client are selected and confirmed (like a PPD). These selected parameters are then added to the Adobe® Job Ticket that is embedded into the PPML/VDX file. If the PPML/VDX file already had a Job Ticket, then the new parameters are merged into the existing data structure. If there was no Job Ticket previously, then one is created and added. The prepress operator selects “Print” and the selected device receives the PPML/VDX file, performs Job Ticket merging, and proceeds to RIP and process the job. Alternatively, the file can be exchanged for printing at a later time by selecting the device to print to. Having the knowledge and experience of the job and the print device, the operator simply moves the PPML/VDX file into a pre-defined and debugged Virtual Printer that has been created on the device (such as the NexStation™ 4). The PPML/VDX file may or may not have an embedded Job Ticket at the time of transfer to NexStation™ 4.

Within the preferred embodiment, the system supports and integrates a NexStation™ 4 print driver as well as a GUI 6 to launch and support a NexStation™ 4 print driver. The GUI 6 allows selection and submission by submitting the PPML/VDX job to the selected device (NexStation™ 4 or other printing device). It is envisioned by the invention to employ network browsing, provided by the system, to locate existing virtual printers or other printing devices for the NexStation™ 4. The invention also envisions future re-printing provided by having the printing device selected by the Job Ticket so that the job can be identically reproduced. Upon selection of a “Print” command, the system software moves the selected PPML/VDX file to the input queue of the selected NexStation™ 4 or other printing device

The foregoing description details the best mode known to the inventors for practicing the invention. Variations of the best mode will be readily apparent to those persons skilled in the relevant arts, therefore, the scope of the invention should be measured by the appended claims.

What is claimed is:

1. A method of preparing a print job for finishing comprising the steps of:
providing a print job defined as a plurality of documents;
creating a file containing status of each of said documents; and
comparing said file with said print job to verify proper printing of said documents.

2. The method of claim 1, wherein the comparing step further comprises responding to a condition wherein at least one of said documents did not correctly print to reprint said at least one of said documents.

3. The method of claim 1, wherein the step of providing further comprises providing said print job defined by a job ticket.

4. The method of claim 3, wherein the step of providing further comprises defining a manufacturing intent within said job ticket.

5. The method of claim 4, wherein said manufacturing intent includes the type of substrate to be used, the number of copies to be made and the finishing characteristics step of identifying further comprises matching elements from layout and product intent to form said group of characteristics.

6. The method of claim 1, wherein the step of creating further comprises said file containing status being updated by logging data related to said documents into said file.

7. The method of claim 1, wherein the step of comparing further comprises responding to instances of incorrect status to correct problems in the printed output.

8. The method of claim 7, wherein the step of comparing further comprises responding to instances of incorrect status by reprinting those of said documents that have incorrect status.

9. The method of claim 7, wherein the step of comparing further comprises responding to instances of multiple or missing feed sheets to eliminate extra sheets from finished documents.

10. The method of claim 1, wherein the step of comparing further comprises the steps of:
determining if any of said documents are not manufactured in their intended state;
preparing a subsequent print job to impose all documents not in their intended state; and
arranging all of said documents for finishing.

11. A system for manufacturing a print job comprising:
a printing device capable of rendering a plurality of documents as defined by said print job;
an electronic file associated with said printing device, said file containing a status of each of said documents; and
a processing element that compares said status of said document within said file with manufacturing intent as defined in said print job and identifies each of said documents that is not imposed as defined in said print job.

12. The system of claim 11, wherein said processing element prepares a sub-job for said documents identified as not being manufactured as defined by said print job.

13. The system of claim 11, wherein said print job is electronically defined in a job ticket.

14. The system of claim 13, wherein said job ticket defines a manufacturing intent for each of said documents in a variable data format.

15. The system of claim 14, wherein said manufacturing intent includes a substrate type, a number of copies to be made and a finishing characteristic.

16. The system of claim 15, wherein said file containing status can be updated by logging data related to said documents into said file.

17. The system of claim 15, wherein said processing element compares said file with said job ticket to determine if said documents are correctly manufactured.

18. The system of claim 17, wherein said processing element responds to incorrect manufacturing of said documents status by reprinting those of said documents that have incorrect status.

19. The system of claim 17, wherein said processing element is coupled to a sensing device that can read an indicia on said documents to compare said file with said job ticket.

20. The system of claim 19, wherein said indicia is a bar code.
